(19) United States
(12) Patent Application Publication
(10) Pub. No.: US 2004/0052509 A1
(43) Pub. Date: Mar. 18, 2004

(54) Optical pick-up device and optical disk apparatus

(75) Inventors: Kenichi Shimada, Yokohama (JP); Kunikazu Ohnishi, Yokosuka (JP); Masayuki Inoue, Yokohama (JP); Yukio Fukui, Machida (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignees: Hitachi, Ltd., Tokyo (JP); Hitachi Media Electronics Co., Ltd., Mizusawa-shi (JP)

(21) Appl. No.: 10/384,264

(22) Filed: Mar. 7, 2003

(30) Foreign Application Priority Data
Sep. 13, 2002 (JP) 2002-267561

(51) Int. Cl. H04N 5/781

(52) U.S. Cl. 386/126

(57) ABSTRACT

Since the working distance of an objective lens for a high-density optical disk is short, in the case where an optical pick-up device in which a plurality of lenses including an objective lens for the high-density optical disk are installed in the same lens holder and an optical disk apparatus that uses the optical pick-up device are used to drive an objective lens to be used for the optical disk, there is high possibility that when one of the objective lenses is focus controlled, the other objective lens may collide with the optical disk, which presents a problem. To resolve the problem, in the optical pick-up device in which a plurality of objective lenses including the objective lens for the high-density optical disk are installed in the same lens holder and in an optical disk apparatus that uses it, relative positions of the objective lenses in the said lens holder in an optical-axis direction are set to predetermined positions.

### BACKGROUND OF THE INVENTION

The present invention relates to an optical pick-up device capable of reproducing or recording a plurality of optical disks each of which has a mutually different recording density, such as DVD, CD, and a high-density optical disk that realizes a capacity several times that of the existing DVD, and to an optical disk apparatus on which the said optical pick-up device is mounted.

Currently, optical disks includes a disk whose transparent substrate has a thickness of 1.2 mm, such as CD-ROM, CD-R, and CD-RW, and that is read or written by a semiconductor laser of a wavelength in a band of approximately 780 nm, and a disk whose transparent substrate has a thickness of 0.6 mm, such as DVD-ROM, DVD-R, and DVD-RW, and that is read or written by a semiconductor laser of a wavelength in a band of approximately 650 nm. Since the substrate thickness and corresponding wavelength are different in this way depending on the kind of the optical disk, in order to make the same optical pick-up device compatible with the DVD and the CD, it is necessary to install objective lenses each of which is compatible with each optical disk on the optical pick-up device. Conventionally, either an optical pick-up device on which a single lens having plural numerical apertures and plural focal lengths is mounted (for example, see a patent reference 1) or an optical pick-up device in which at least two different lenses are installed in the same lens holder thereof (for example, see a patent reference 2) was used.

[Patent Reference 1]

JP-A No. 331362/2000

[Patent Reference 2]

JP-A No. 297927/1997

At present, there is being standardized a high-density optical disk that realizes a capacity several times that of the existing DVD by using a blue-violet semiconductor laser in a wavelength band of 400 nm as a recording/reproducing semiconductor laser and reducing the thickness of its transparent substrate to 0.1 mm. However, the objective lens that is compatible with the CD, the DVD, and the high-density optical disk only by itself has not been disclosed or published yet. Therefore, in order to make the optical pick-up device compatible with these optical disks, it is considered possible to mount on the optical pick-up device at least two kinds of objective lenses, that is, the DVD/CD-compatible special lens and such an objective lens for the high-density optical disk as is described in Technical Digest of Optical Data Storage Topical Meeting held in April 2001 (pp. 100-102). Further, since the optical pick-up device is required to fulfill miniaturization, simplification, and low pricing, it is preferable that the above-mentioned objective lenses are driven by the same actuator.

Here, because the working distance of the objective lens for the high-density optical disk is extremely short as compared to the working distance of the objective lens for the DVD/CD, in the case where a plurality of objective lenses are driven by the single actuator, there gives rise to an important problem that when one of the objective lenses is brought into focusing or in case the one lens goes out of focus, collision of the other objective lens with the optical disk must be prevented.

The patent application described in the above-mentioned JP-A No. 297927/1997 is such that a difference in the mount height between a plurality of objective lenses is set equal to a difference between both working distances in order to reduce power consumption in the actuator and nothing is considered for prevention of the disk collision.

On the other hand, a technology for preventing collision between the objective lenses and the optical disk in the case where a plurality of objective lenses including the objective lens for the high-density optical disk are driven by the same actuator is disclosed in, for example, JP-A No. 67700/2001. However, since a technological idea that is disclosed there is a method of preventing direct collision between the objective lenses and the optical disk by providing a buffer part in a lens holder, it can prevent the optical disk from being damaged or hurt but cannot prevent direct collision between the buffer part and the optical disk, consequently having high possibility that the optical disk may be damaged.

### SUMMARY OF THE INVENTION

The present invention aims to provide a technology of preventing direct collision between the objective lenses and the optical disk without providing the buffer part and therefore preventing the optical disk and the objective lenses from being damaged in the case where a plurality of objective lenses including the objective lens for the high-density optical disk are driven by the same actuator.

In order to resolve the problem, in one preferred aspect, this invention utilizes an optical disk apparatus comprises: a turntable on which either a first optical disk or a second optical disk is placed and held; an optical pick-up device in which a first objective lens for focusing a light beam on the first optical disk and a second objective lens for focusing a light beam on the second optical disk are installed in the same lens holder; and controlling means for controlling a position of the lens holder so that a distance between the lens holder and the lens-holder-side surface of the second optical disk when the second optical disk is being reproduced is longer than a distance between the lens holder and the lens-holder-side surface of the first optical disk when the first optical disk is being reproduced. Here, the controlling means, for example, means a control circuit.

In another aspect, this invention utilizes the optical disk apparatus comprising: the turntable on which either the first optical disk or the second optical disk is placed and held; the optical pick-up device in which the first objective lens for focusing a light beam on the first optical disk and the second optical disk for focusing a light beam on the second optical disk are installed in the same lens holder; controlling means for controlling a position of the lens holder so that a distance between the lens holder and the lens-holder-side surface of the second optical disk when the second optical disk is being reproduced is longer than a distance between the lens holder and the lens-holder-side surface of the first optical disk when the first optical disk is being reproduced, characterized in that denoting the working distance of the first objective lens installed at the near side from the optical disk as WDₛ, the working distance of the second objective lens installed at the far side from the optical disk as WD₁, and a maximum value of the deviation of recording layer positions of the second optical disk in an optical-axis direction that is generated by rotation of the second optical disk as δD₁, and further denoting a difference between a distance from the lens holder to the lens-holder-side surface of the second optical disk when the light beam passes through the second objective lens and is in focus on the second optical disk and a distance from the lens holder to the lens-holder-side surface of the first optical disk when the light beam passes through the first objective lens and is in focus on the first optical disk as α, the α satisfies α>δD₁−WDₛ. Here, denoting the working distance of the first objective lens as A, the working distance of the second objective lens as B, and a maximum value of the deviation of recording layer positions of the second optical disk as δB; WDₛ and WD₁ means A and B when the first objective lens is placed at a nearer side from the lens-side surface of the optical disk than the second objective lens is, respectively, and δD₁ means a maximum value δB of the deviation of recording layer positions of the second optical disk.

In still another aspect, this invention utilizes the optical pick-up device in which the first objective lens for focusing a light beam on the first optical disk and the second objective lens for focusing a light beam on the second optical disk are installed in the same lens holder, characterized in that denoting the working distance of the first objective lens installed at the near side from the optical disk as WDₛ and the working distance of the second objective lens installed at the far side from the optical disk as WD₁, the first objective lens and the second objective lens are installed in the lens holder so that a difference X between a distance from a vertex position of the optical-disk-side surface of the first objective lens to the optical disk in the optical-axis direction and a distance from a vertex position of the optical-disk-side surface of the second objective lens X to the optical disk satisfies 0≦X<WD₁−WDₛ (where WD₁>WDₛ).

In yet another aspect, this invention utilizes an optical disk apparatus comprising: the optical pick-up device in which the first objective lens for focusing a light beam on the first optical disk and the second objective lens for focusing a light beam on a second optical disk are installed in the same lens holder, the turntable on which either the first optical disk or the second optical disk is placed and held; and a control circuit for switching the objective lens according to a kind of the optical disk that is placed and held on the turntable, characterized in that denoting the working distance of the first objective lens installed at the near side from an optical disk placed and held on the turntable as WDₛ and the working distance of the second objective lens installed at the far side from the optical disk placed and held on the turntable as WD₁, the first objective lens and the second objective lens are installed in the lens holder so that a difference X between a distance from a vertex position of the optical-disk-side lens surface of the first objective lens to the optical disk in the optical-axis direction and a distance from a vertex position of the optical-disk-side lens surface of the second objective lens to the optical disk satisfies 0≦X<WD₁−WDₛ (where WD₁>WDₛ).

Note that also in the optical pick-up device described in the conventional example that is compatible with plural kinds of optical disks with the use of a single lens, the lens holder is moved vertically when a different kind of optical disk is being reproduced or recorded, but this operation is done simply in order to keep the distance between the optical disk and the lens holder so that the distance becomes different by the amount of a difference of the working distances for the respective optical disks and is not done in view of such prevention of collision between the objective lenses and the optical disk as can be achieved by the present invention.

This invention can provide an optical pick-up device in which an actuator capable of preventing the collision between the objective lenses and the optical disk and causing no damages on the disk, and an optical disk apparatus that uses the optical pick-up device.

### BRIEF DESCRIPTION OF THE DRAWININGS

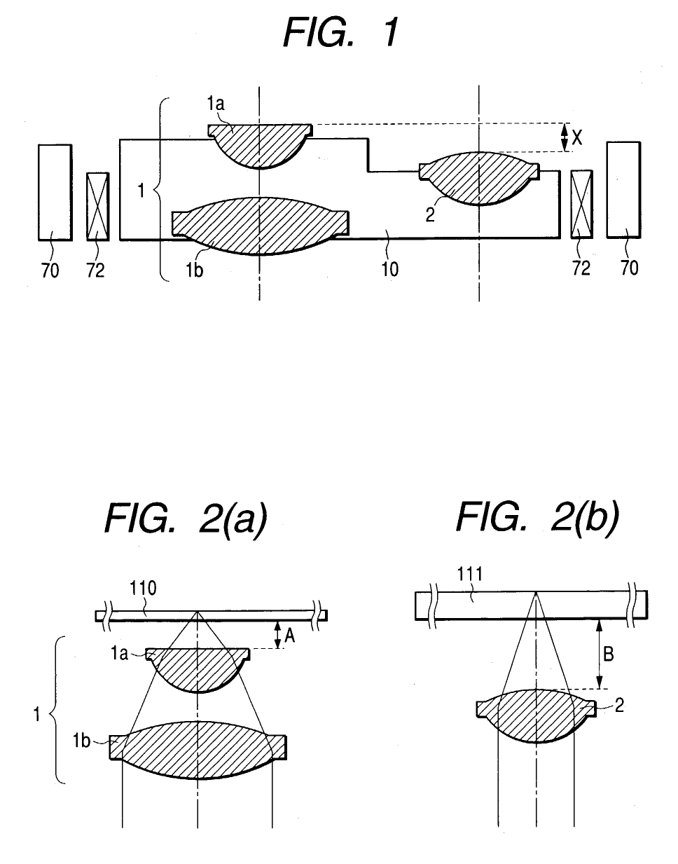

FIG. 1 shows an embodiment regarding the actuator according to this invention.

FIGS. 2(A) and (B) are views each showing the working distance. FIG. 2(A) shows the working distance of the objective lens for the high-density optical disk. FIG. 2(B) shows the working distance of an objective lens for the existing DVD.

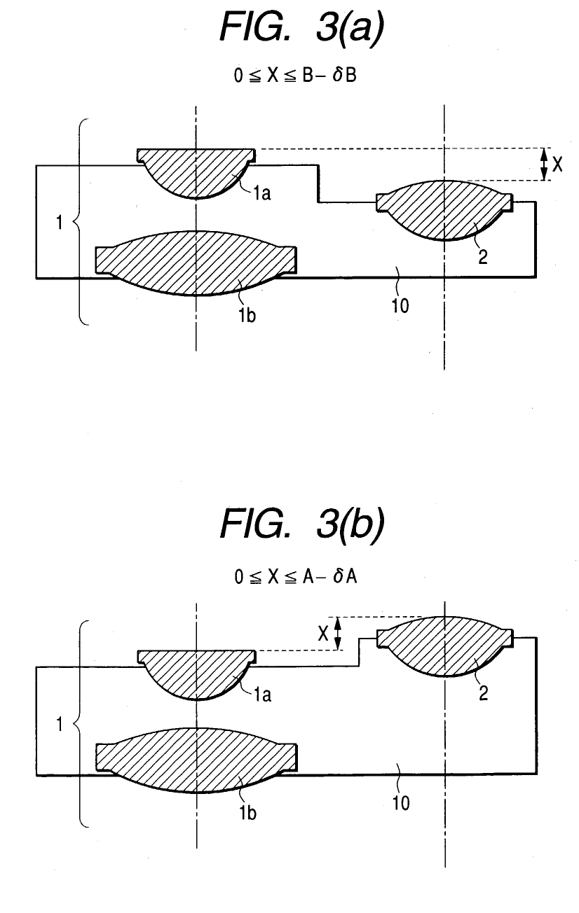

FIGS. 3(A) and (B) are views each showing positions of the objective lens for the high-density optical disk and of the objective lens for the existing DVD. FIG. 3(A) is a view for the case where an objective lens 1 is placed at the near side from the optical disk. FIG. 3(B) is a view for the case where an objective lens 2 is placed at the near side from the optical disk.

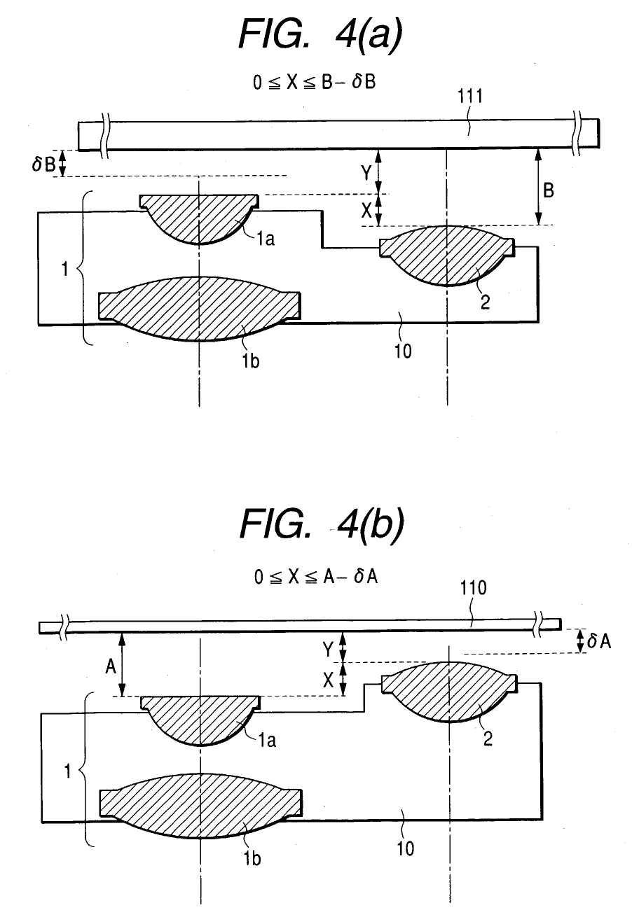

FIGS. 4(A) and (B) are views each showing the space between the optical disk and the objective lens in the presence of disk surface deflection. FIG. 4(A) shows the space between the objective lens for the high-density optical disk. FIG. 4(B) shows the space between the objective lens for the existing DVD and the high-density optical disk.

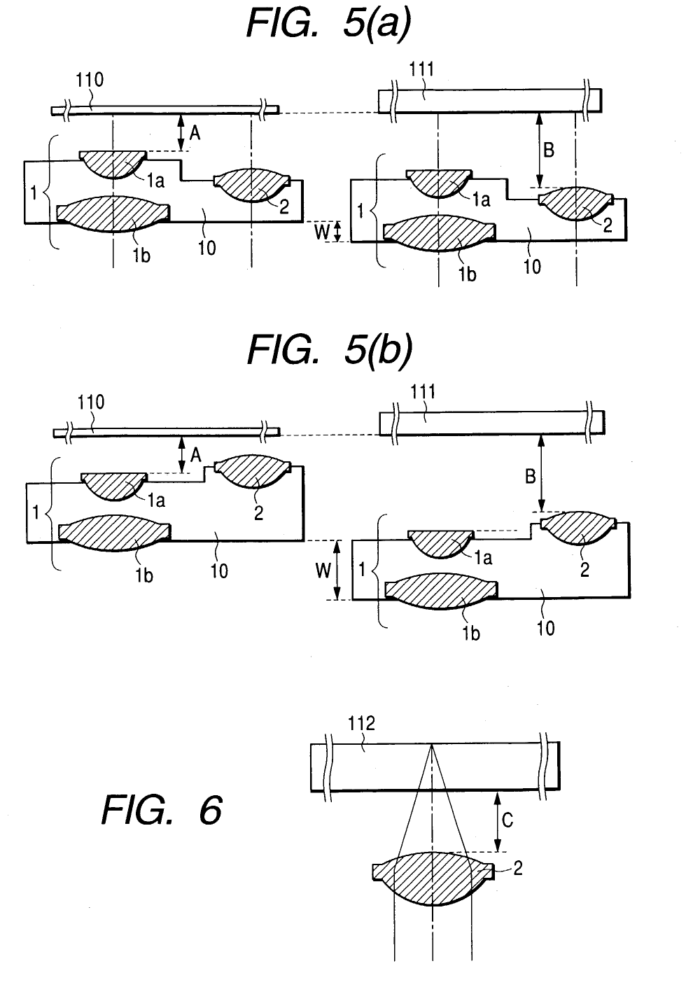

FIGS. 5(A) and (B) are views each showing a difference in the lens holder position between when the high-density optical disk is being reproduced and when the existing DVD is being reproduced. FIG. 5(A) shows the difference in the lens holder position in the case where the objective lens 1 is placed at the near side from the optical disk. FIG. 5(B) shows the difference of the lens holder positions in the case where the objective lens 2 is placed at the near side from the optical disk.

FIG. 6 shows the working distance of the DVD/CD-compatible special objective lens when being used for the CD.

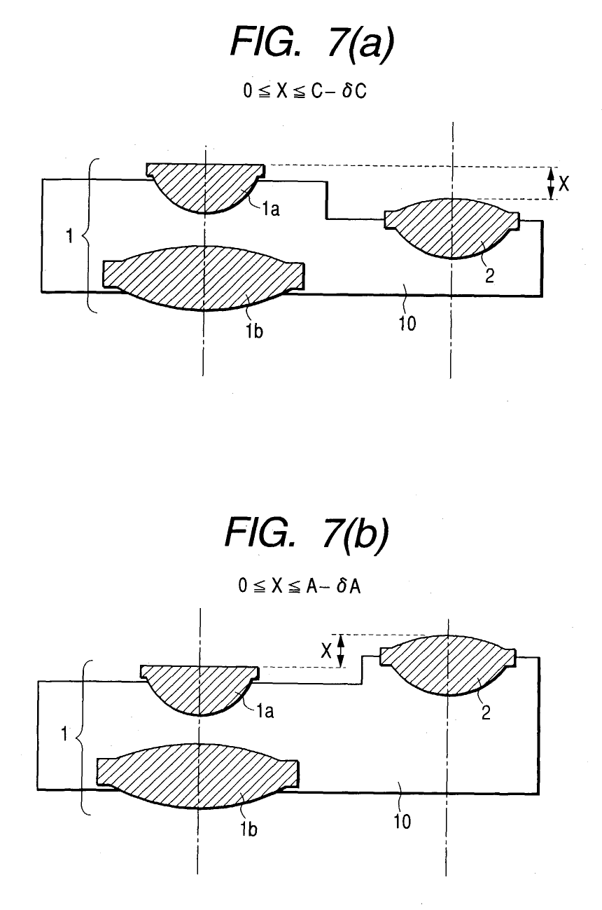

FIGS. 7(A) and (B) are views each showing positions of the objective lens for the high-density optical disk and of the DVD/CD-compatible special objective lens. FIG. 7(A) shows the positions in the case where the objective lens 1 is placed at the near side from the optical disk. FIG. 7(B) shows the positions in the case where the objective lens 2 is placed at the near side from the optical disk.

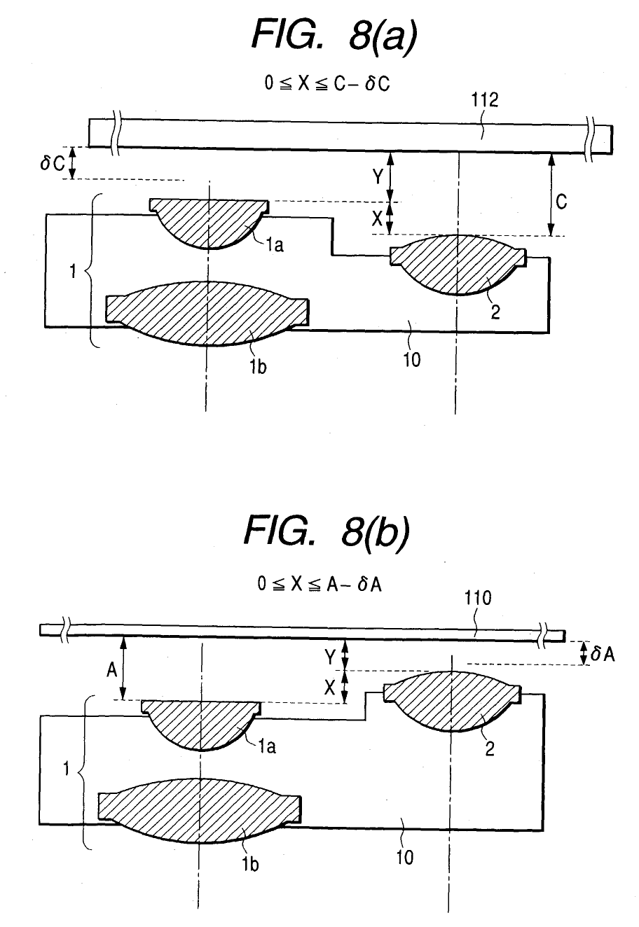

FIGS. 8(A) and (B) are views each showing the space between the optical disk and the objective lens in the presence of disk surface deflection. FIG. 8(A) shows the space between the objective lens for the high-density optical disk and the CD disk. FIG. 8(B) shows the space between the DVD/CD-compatible special objective lens and the high-density optical disk.

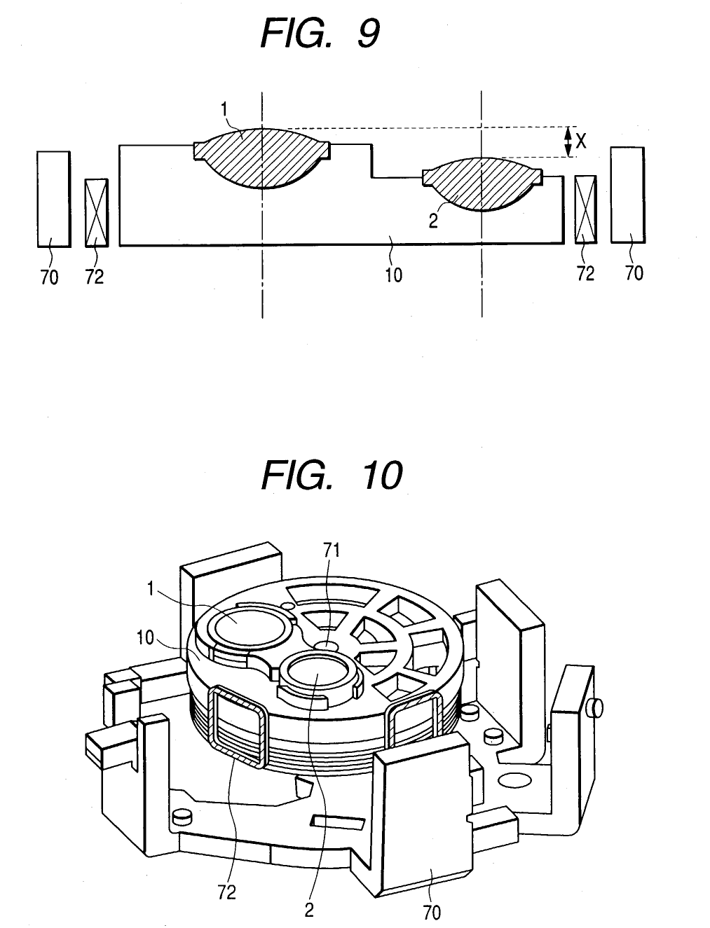

FIG. 9 shows an actuator on which the objective lens for the high-density optical disk of a single-lens configuration.

FIG. 10 shows an axial sliding type actuator.

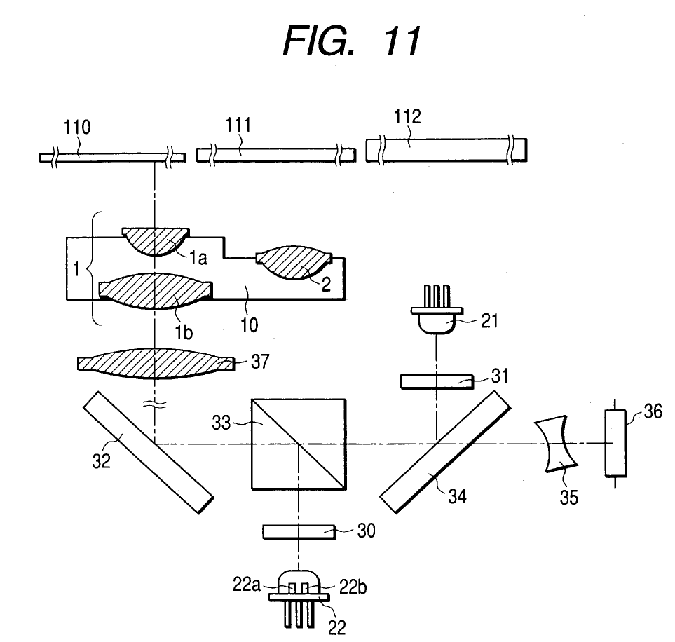

FIG. 11 shows a first embodiment regarding the optical pick-up device according to this invention.

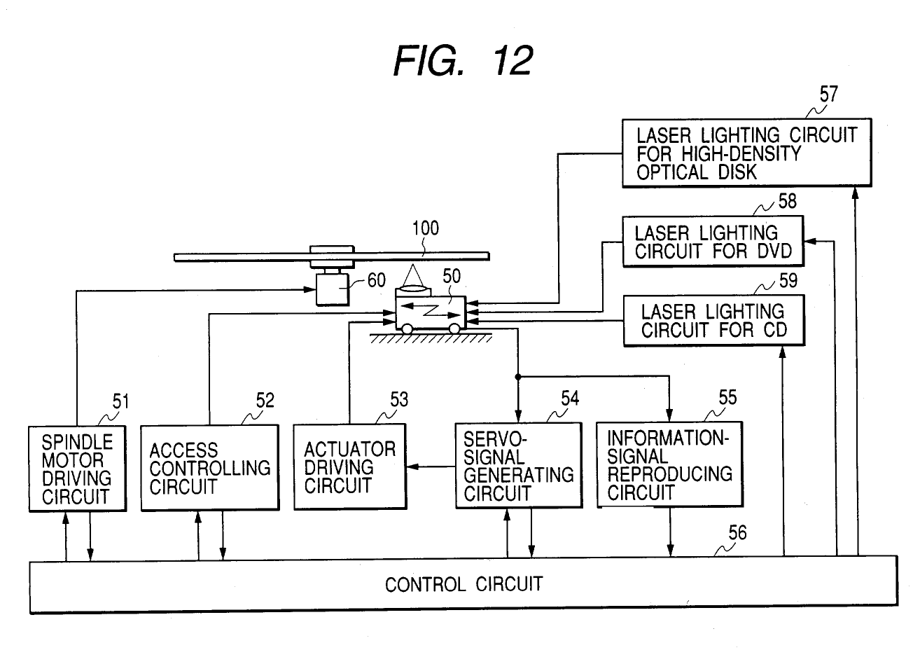

FIG. 12 shows an embodiment regarding the optical disk apparatus according to this invention.

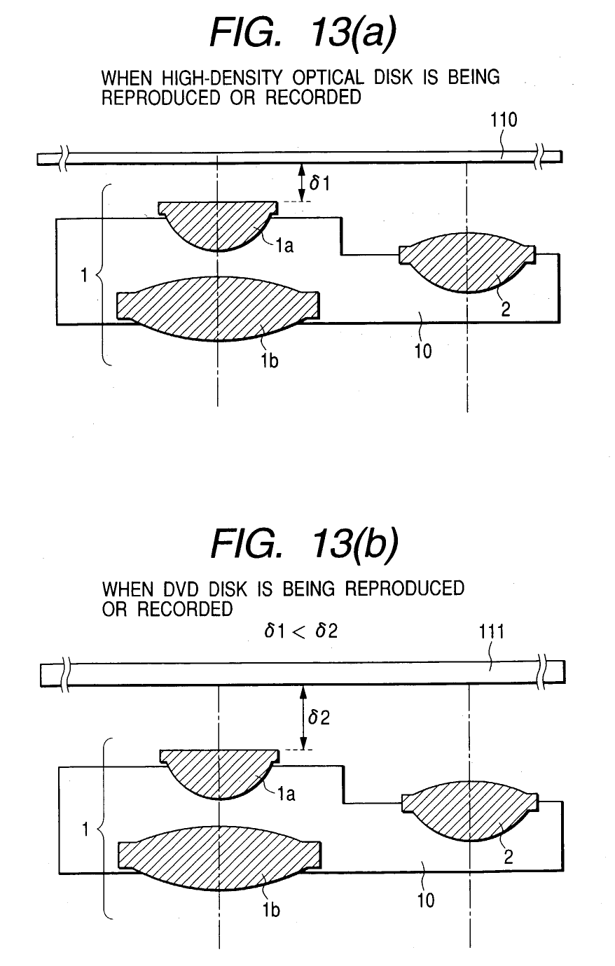

FIGS. 13(A) and (B) are views each showing an embodiment regarding a lens holder position according to this invention. FIG. 13(A) shows a position of the lens holder when the high-density optical disk 110 is being reproduced or recorded. FIG. 13(B) shows a position of the lens holder when the existing DVD disk 111 is being reproduced or recorded.

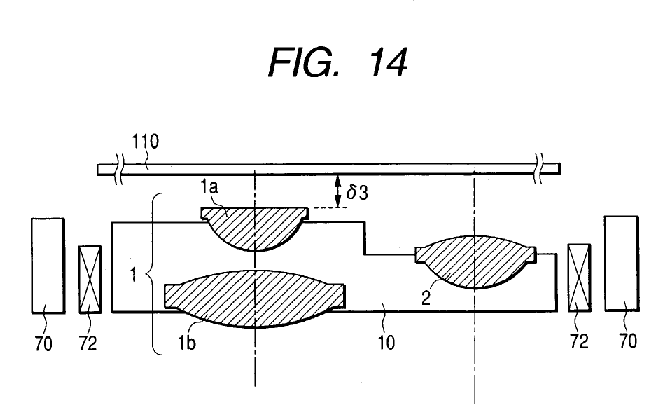

FIG. 14 shows an embodiment regarding movement of the lens holder in the optical-axis direction according to this invention.

### DETAILED DESCRIPTION OF THE PREFERRED EMBODIMENTS

FIGS. 13(A) and (B) are views each showing an embodiment of the optical disk apparatus regarding the lens holder position according to this invention. In FIGS. 13(A) and (B), the numeral 10 indicates a lens holder, and FIGS. 13(A) and (B) are views each showing a position of the lens holder 10 when the optical disk is being reproduced or recorded.

In this embodiment, the lens holder 10 is provided with the objective lens 1 and the objective lens 2 that are compatible with the optical disks each having a mutually different recording density, respectively, wherein the objective lens 1 is specified to be the objective lens for the high-density optical disk that is compatible with a disk of a transparent substrate thickness of, for example, 0.1 mm, more specifically, to be an objective lens composed of a lens 1a and a lens 1b constituting a two-lens combination just as the above-mentioned objective lens for the high-density optical disk as described above.

Further, the objective lens 2 is specified to be the objective lens for the existing DVD that is compatible with a disk of a transparent substrate thickness of, for example, 0.6 mm. Note that the objective lens 2 is not limited to the objective lens exclusive for DVD that is compatible with the existing DVD disk, but it is perfectly all right that it is an objective lens that is compatible with a plurality of optical disks each having a different recording density such as the DVD/CD-compatible special objective lens that is also compatible with the CD disk. The objective lens 2 may be the DVD/CD-compatible special objective lens as described above.

Note here that the lens holder 10 moves in the optical-axis direction for focal adjustment so that the light beam emitted from either the objective lens 1 or the objective lens 2 becomes in focus on the information recording surface of the optical disk that is intended to be reproduced or recorded therewith.

FIG. 13(A) shows a position of the lens holder 10 when the high-density optical disk 110 is being reproduced or recorded, that is, when the light beam emitted from the objective lens 1 becomes in focus on the information recording surface of the optical disk that is intended to be reproduced or recorded therewith. FIG. 13(B) shows a position of the lens holder 10 when the existing DVD disk 111 is being reproduced or recorded, that is, when the light beam emitted from the objective lens 2 becomes in focus on the information recording surface of the optical disk that is intended to be reproduced or recorded therewith.

In this embodiment, denoting a space between the objective lens 1 and the high-density optical disk 110 when the high-density optical disk 110 is being reproduced or recorded as δ1 and a space between the objective lens 1 and the existing DVD disk 111 when the existing DVD disk 111 is being reproduced or recorded as δ2, the objective lens 1 and the objective 2 are installed in the lens holder 10 so that a position of the lens holder satisfies δ1<δ2.

Thus, when the existing DVD disk 111 is being reproduced or recorded, the space between the objective lens 1 and the existing DVD disk 111 is opened out, which can reduce the possibility that the objective lens 1 may collide with the existing DVD disk 111 in case the objective lens 2 gets out of the control of a focusing servo or when it is brought into focusing.

As shown in FIG. 14, a coil 72 is assembled in the lens holder 10. Feeding a current through the coil 72 causes the lens holder 10 to move in the optical-axis direction by interaction with a magnetic circuit part indicated by the numeral 70, enabling focus adjustment.

Denoting a space between the optical disk and the objective lens 1 when the coil 72 is not fed with the current as δ3, the lens holder 10 is installed so that δ3, for example, satisfies δ1≦δ3 in this invention.

Therefore, when the high-density optical disk 110 is being reproduced or recorded in the case of δ1<δ3, it is necessary to bring a position of the lens holder 10 close to the optical disk by (δ3−δ1) as compared to a state of no current being fed through the coil 72. Therefore, in this case, when the high-density optical disk 110 is being reproduced or recorded, it follows that a direct current (offset) equivalent to lifting up the lens holder 10 by (δ3−δ1) is passing through the coil 72.

Note that satisfying δ1≦δ3 makes the following possible: to widen a space between the optical disk and the objective lens 1 in a state of no current being fed through the coil 72; and to reduce the risk of collision between the optical disk and the objective lens 1 that is generated by surface deflection of the high-density optical disk 110, the existing DVD disk 111, or the CD disk 111 when the high-density optical disk 110, the existing DVD disk 111, or the CD disk 111 is rotated in a state of no current being fed through the coil 72.

Further, in the embodiment of FIG. 13, there is a difference in direct current (offset) corresponding to (δ2−δ1) between when the high-density optical disk 110 is being reproduced or recorded and when the existing DVD disk 111 is being reproduced or recorded.

Further FIG. 1 shows an embodiment regarding the optical pick-up device according to this invention. In FIG. 1, the numeral 10 indicates a lens holder, the numeral 70 is a magnetic circuit part, and the numeral 72 is a coil.

In this embodiment, the lens holder 10 is provided with the objective lens 1 and the objective lens 2 each of which is compatible with an optical disk having a mutually different recording density, and more specifically, the objective lens 1 is specified to be the objective lens for the high-density optical disk that is compatible with a disk of a transparent substrate thickness of 0.1 mm and is composed of the lens 1a and the lens 1b constituting a two-lens combination just as the objective lens for the high-density optical disk as described above. Further, the objective lens 2, for example, is specified to be the objective lens for the existing DVD that is compatible with a disk of a transparent substrate thickness of 0.6 mm.

Here, denoting the working distance of the objective lens 1 for a light beam used in recording or reproducing the high-density optical disk 110 (hereinafter referred to as the optical disk 110 for convenience) as A, the working distance of the objective lens 2 for a light beam used in recording or reproducing the existing DVD disk 111 (hereinafter referred to as the optical disk 111) as B, as shown in FIG. 2, (incidentally, the numerical aperture of the objective lens 1, for example, is specified to approximately 0.75 to 0.90, and the numerical aperture of the objective lens 2, for example, is specified to approximately 0.60 to 0.67) and further denoting an absolute value of a difference between a distance from a vertex position of the optical-disk-side lens surface of the objective lens 1 to the optical disk in the optical-axis direction and a distance from a vertex position of the optical-disk-side lens surface of the objective lens 2 to the optical disk as X, in this embodiment, the objective lens 1 and the objective lens 2 are installed so that in the case where the objective lens 1 is installed at a nearer side from the optical disk than the objective lens 2 is, X satisfies 0≦X≦B−δB as shown in FIG. 3(A), and in the case where the objective lens 2 is installed at a nearer side from the optical disk than the objective lens 1 is, X satisfies 0≦X≦A−δA as shown in FIG. 3(B).

Note that δA in 0≦X≦A−δA is a maximum of the deviation of recording layer positions of the optical disk 110 in the optical-axis direction that is generated when the optical disk 110 is being reproduced or recorded (hereinafter referred to as the amount of surface deflection of the optical disk 110 for convenience), and δB in 0≦X≦B−δB is a maximum of the deviation of recording layer positions of the optical disk 111 in the optical-axis direction that is generated when the optical disk 111 is being reproduced or recorded (hereinafter referred to as the amount of surface deflection of the optical disk 111 for convenience).

Arranging the objective lens 1 and the objective lens 2 in this way makes it possible to reduce the possibility that an objective lens at the near side from the optical disk may collide with the optical disk in case an objective lens at the far side from the optical disk, namely the objective lens 2 in FIG. 3(A) and the objective lens 1 in FIG. 3(B), gets out of the control of the focusing servo.

For example, as shown in FIG. 4(A), in case the objective lens 2 gets out of the control of the focusing servo when the optical disk 111 is being reproduced or recorded, a space between the objective lens 2 and the optical disk 111 immediately thereafter is open by the working distance B of the objective lens 2. Therefore, with the arrangement of the objective lenses shown in FIG. 3(A) that satisfies 0≦X≦B−δB, it is possible to keep a space Y equal to or more than δB that is a maximum value of the amount of surface deflection of the optical disk 111 between the objective lens 1 and the optical disk 111 in a state of zero surface deflection, as shown in FIG. 4(A).

Moreover, as shown in FIG. 4(B), in case the objective lens 1 gets out of the control of the focusing servo when the optical disk 110 is being reproduced or recorded, a space between the objective lens 1 and the optical disk 110 immediately thereafter is open by the working distance A of the objective lens 1. Therefore, with the arrangement of the objective lenses shown in FIG. 3(B) that satisfies 0≦X≦A−δA, it is possible to keep a space Y equal to or more than δA that is a maximum value of the amount of surface deflection of the optical disk 110 between the objective lens 2 and the optical disk 110 in the state of zero surface deflection, as shown in FIG. 4(B).

That is, even if the surface deflection of the disk occurs immediately after the objective lens at the far side from the optical disk got out of the control of the focusing servo, this arrangement can prevent direct collision between the objective lens at the near side from the optical disk and the optical disk. Here, the surface deflection (the deviation of recording layer positions) is measured on conditions described in JIS X 6243 (120-mm DVD rewritable disk), p.4, Item 8.1.1 “Test environment conditions,” ibid., p.64, Attachment A (Stipulations) “Measurement of angle deviation α,” etc. using, for example, DVD Mechanical Characteristics Measurement System LM-1200 (DVD) of ONO SOKKI CO., LTD. or the like. Further, the above-mentioned maximum of the deviation may be a maximum of deviation of 0.3 mm described in the above-mentioned JIS X 6243, p. 11, Item 11.5.1 “Amount of deflection in axial direction.”

Here, in the case where objective lenses having different working distances are driven by the same actuator, it is advantageous that an objective lens of a longer working distance is installed at the far side from the optical disk in consideration of the power consumption in the actuator and a movable range that is required. For example, assuming that the working distance B of the objective lens 2 is longer than the working distance A of the objective lens 1, pay attention to a difference between a position of the lens holder when the optical disk 110 is being reproduced and a position of the lens holder when the optical disk 111 is being reproduced. The difference W can be made small in the case where the objective lens 2 of a longer working distance is installed at the far side from the optical disk as shown in FIG. 5(A), as compared to a case where the objective lens 2 is installed at the near side from the optical disk as shown in FIG. 5(B). If this difference W arises, a direct current is always needed in order to lift up the lens holder when the disk is being reproduced or recorded, and as the difference W becomes larger, the power consumption increases accordingly. Moreover, a movable range that is required for the actuator also becomes wide.

Therefore, in this embodiment, to reduce the power consumption in the actuator and narrow the movable range that is required for the actuator as well as to prevent the collision between the optical disk and the objective lens, it is more preferable to install the objective lens of a longer working distance at the far side from the optical disk. As the difference X of the objective lenses becomes closer to the absolute value of the difference in working distance |A−B|, this installation can reduce the power consumption and narrow the movable range further. Therefore, by installing the objective lens of a longer working distance at the far side from the optical disk and additionally by installing the objective lens 1 and the objective lens 2 so that in the case where the working distance B of the objective lens 2 is longer than the working distance A of the objective lens 1, A and B satisfy (B−A)/2≦X≦B−δB, and in the case where the working distance B of the objective lens 2 is shorter than the working distance A of the objective lens 1, A and B satisfy (A−B)/2≦X≦A−δA, it is possible to further reduce the power consumption and also narrow the movable range that is required for the actuator as compared to those of such an arrangement of the objective lenses as satisfies 0≦X≦B−δB or 0≦X≦A−δA.

Here, note that the working distance of the objective lens for the high-density optical disk is generally shorter than the working distance of the objective lens for the existing DVD. Because of this fact, suppose that the objective lens 1 and the objective lens 2 are installed so that A and B satisfy 0≦X≦B−δB or (B−A)/2≦X≦B δB−δB to reduce the power consumption in the actuator and narrow the movable range that is required for the actuator as well as to prevent the collision between the optical disk and the objective lens. In this case, as a concrete numerical value of δB in 0≦X≦B−δB or (B−A)/2≦X≦B−δB, δB in this embodiment, for example, becomes approximately 0.3 mm since the deviation of recording layer positions from a nominal position in a direction perpendicular to the disk reference plane is stipulated to be 0.3 mm or less in the existing DVD Disk Standard Book. Therefore, for example, if the working distance A is set to approximately 0.1 mm and the working distance B is set to approximately 1.7 mm, a range of X as defined by 0≦X≦B−δB becomes 0 mm≦X≦1.4 mm and a range of X as defined by (B−A)/2≦X≦B−δB becomes 0.8 mm≦X<1.4 mm.

Incidentally, in this embodiment, the objective lens 2 is not limited to the objective lens exclusive for the DVD that is compatible with the existing DVD disk but it is perfectly all right that the objective lens is an objective lens that is compatible with a plurality of optical disks each having different recording density, such as the DVD/CD-compatible special objective lens that is also compatible with the CD disk. The objective lens 2 may be the DVD/CD-compatible special objective lens as described above. In this case, denoting the working distance of the objective lens 2 for a light beam that is used in recording or reproducing the CD disk 112 (hereinafter referred to as the optical disk 112 for convenience) as shown in FIG. 6 as C, the objective lens 1 and the objective lens 2 are installed so that in the case where the objective lens 1 is installed at a nearer side from the optical disk than the objective lens 2 as shown in FIG. 7(A), X satisfies 0≦X≦C−δC, and in the case where the objective lens 2 is installed at a nearer side from the optical disk than the objective lens 1 as shown in FIG. 7(B), X satisfies 0≦X≦A−δA.

Note that δA in 0≦X≦A−δA is a maximum value of the amount of surface deflection of the optical disk 110, as described above, and δC in 0≦X≦C−δC is a maximum value of the deviation of recording layer positions of the optical disk 112 in the optical-axis direction that is generated by disk rotation (hereinafter referred to as the amount of surface deflection of the optical disk 112 for convenience).

Arranging the objective lens 1 and the objective lens 2 in this way makes it possible to decrease the possibility that the objective lens at the near side from the optical disk may collide with the optical disk in case the objective lens at the far side from the optical disk gets out of the control of the focusing servo. For example, in case the objective lens 2 gets out of control of the focusing servo when the optical disk 112 is being reproduced or recorded, the space between the objective lens 2 and the optical disk 112 immediately thereafter is open by the working distance C of the objective lens 2. Therefore, with the arrangement of the objective lenses shown in FIG. 7(A) that satisfies 0≦X≦C−δC, it is possible to keep a space Y equal to or more than δC that is a maximum value of the amount of surface deflection of the optical disk 112 between the objective lens 1 and the optical disk 112 in the state of zero surface deflection, as shown in FIG. 8(A).

Further, in case the objective lens 1 gets out of control of the focusing servo when the optical disk 110 is being reproduced or recorded, the space between the objective lens 1 and the optical disk 110 immediately thereafter is open by the working distance A of the objective lens 1. Therefore, with the arrangement of the objective lenses shown in FIG. 7(B) that satisfies 0≦X≦A−δA, it is possible to keep the space Y equal to or more than δA that is a maximum value of the amount of surface deflection of the optical disk 110 between the objective lens 2 and the optical disk 110 that is in the state of zero surface deflection, as shown in FIG. 8(B).

That is, even if the surface deflection of the disk occurs immediately after the objective lens at the far side from the optical disk got out of the control of the focusing servo, this arrangement can prevent direct collision between the objective lens at the near side from the optical disk and the optical disk.

In addition, as described above, considering the power consumption in the actuator and the movable range that is required, in the case where the objective lenses having different working distances are driven by the same actuator, it becomes advantageous that the objective lens of a longer working distance is installed at the far side from the optical disk. Therefore, to reduce the power consumption in the actuator and narrow the movable range that is required for the actuator, it is more desirable to install the objective lens of a longer working distance, of the working distance A of the objective lens 1 and the working distance C of the objective lens 2, at the far side from the optical disk. As the difference X of the objective lenses comes close to the absolute value of the difference in the working distance |A−C|, in the case where the high-density optical disk and the CD disk are being reproduced or recorded, this installation can reduce the power consumption in the actuator and narrow the movable range further. Therefore, by installing the objective lens of a longer working distance at the far side from the optical disk and additionally by installing the objective lens 1 and the objective lens 2 so that in the case where the working distance C of the objective lens 2 is longer than the working distance A of the objective lens 1, A and C satisfy (C−A)/2≦X≦C−δC, and in the case where the working distance C of the objective lens 2 is shorter than the working distance A of the objective lens 1, A and C satisfy (A−C)/2≦X≦A−δA, it is possible to reduce the power consumption and also narrow the movable range that is required for the actuator as compared to those of such an arrangement of the objective lenses as satisfies 0≦X≦A−δA or 0≦X≦C−δC.

Here, note that the working distance of the objective lens for the high-density optical disk is generally shorter than the working distance of the DVD/CD-compatible special objective lens. Because of this fact, suppose that the objective lens 1 and the objective lens 2 are installed so that A and C satisfy 0≦X≦C−δC or (C−A)/2≦X≦C−δC to reduce the power consumption in the actuator and narrow the movable range that is required for the actuator as well as to prevent the collision between the optical disk and the objective lens. In this case, as a concrete numerical value of δC in 0≦X≦C−δC or (C−A)/2≦X≦C−δC in this embodiment, for example, becomes approximately 0.3 mm since the deviation of recording layer positions from a nominal position in a direction perpendicular to the disk reference plane is stipulated to be 0.3 mm or less in the CD Disk Standard Book. Therefore, for example, assuming that the working distance A is set to approximately 0.1 mm and the working distance B is set to approximately 1.3 mm, a range of X as defined by 0≦X≦C−δC becomes 0 mm≦X≦1.0 mm and a range of X as defined by (C−A)/2≦X≦C−δC becomes 0.6 mm≦X≦1.0 mm.

Incidentally, in this embodiment, the objective lens for the high-density optical disk 1, for example, is an objective lens composed of the lens 1a and the lens 1b constituting a two-lens combination, but the objective lens according to this invention is not limited to this. For example, the objective lens for the high-density optical disk 1 may be a single lens as shown in FIG. 9.

Further, as shown in FIG. 10, the actuator in this embodiment, for example, is the axial sliding type actuator. In FIG. 10, the objective lens 1 and the objective lens 2 are installed in a cylindrical lens holder 10, which has a structure that allows switching of the objective lens 1 and the objective lens 2 rotationally about an axis 71 in accordance with the optical disk to be recorded or reproduced. Further, by feeding a current through the coil 72, the objective lens is driven to change its position in the focusing direction and in the tracking direction. Incidentally, the numeral 70 indicates a magnetic circuit part.

Next, FIG. 11 shows first and second embodiments regarding the optical pick-up device according to this invention. In this embodiment, an actuator to be mounted therein is the actuator that was described in the embodiment regarding the actuator according to this invention. In FIG. 11, a laser light source 22 is a two-wavelength multi-laser light source in which, for example, a semiconductor laser light source 22a of an oscillation wavelength in a 650 nm band and a semiconductor laser light source 22b of an oscillation wavelength in a 780 nm band are mounted on the same package, and the laser light source 21, for example, is a semiconductor laser light source of an oscillation wavelength in a 400 nm band. These light sources are made to emit light selectively according to an optical disk to be reproduced or recorded.

Further, in FIG. 11, the numerals 30 and 31 indicate diffraction gratings, the numeral 32 is a riser mirror, the numerals 33 and 34 are beam splitters, the numeral 35 is a detection lens, the numeral 36 is a photodetector, and the numeral 37 is a collimator lens. Note that description is omitted for a roll of each optical component, a light-detecting plane pattern in the photodetector 36, and a servo signal detection system that is used in recording or reproducing the optical disks 110, 111, and 112.

Although this embodiment relates to an optical pick-up device that is compatible with the DVD, the CD, and the high-density optical disk, in the case of the second embodiment where the compatibility with the CD is not considered, the pick-up device can be modified to match such a purpose, for example, by specifying the laser light source 22 of FIG. 11 to have only a semiconductor laser source 22a of an oscillation wavelength in the 650 nm band.

Next, FIG. 12 is view showing an embodiment regarding an optical disk apparatus according to this invention. In FIG. 12, an optical pick-up device 50 has a constitution, for example, as shown in FIG. 11.

Various detection signals detected by the optical pick-up device 50 are sent to a servo-signal generating circuit 54 and an information-signal reproducing circuit 55 in a signal processing circuit. From these detection signals, the servo-signal generating circuit 54 generates a focusing error signal and a tracking error signal suitable for each optical disk, and based on these signals an objective lens actuator in the optical pick-up device 50 is driven through the actuator driving circuit 53 to perform position control of the objective lens.

Further, the information-signal reproducing circuit 55 reproduces an information signal that is recorded in the optical disk 100 from the above-mentioned detection signal. Further, a part of the signals obtained by the above-mentioned servo signal reproducing circuit 54 and information-signal reproducing circuit 55 is sent to a control circuit 56. The control circuit 56 has functions of: judging a kind of the optical disk 100 that is intended to be reproduced at that time using these various signals; driving one of a laser lighting circuit for high-density optical disk 57, a laser lighting circuit for DVD 58, and a laser lighting circuit for CD 59 according to a judgment result; and further switching a circuit configuration of the servo-signal generating circuit 54 so as to select a servo signal detection system that matches the kind of the optical disk, as described in the foregoing. Moreover, the control circuit 56 performs control of feeding a direct current (offset) corresponding to (δ2−δ1) and (δ3−δ1) that was described in the embodiments illustrated in FIG. 13 and FIG. 14 through the coil of the actuator. Here, in the case where the optical pick-up device 50 is a device that is not compatible with, for example, the CD, the laser lighting circuit for CD 59 is unnecessary.

Further, an access controlling circuit 52 and a spindle motor driving circuit 51 are connected to the control circuit 56, and these circuits perform access-direction and position control of the optical pick-up device 50 and rotation control of a spindle motor 60 for the optical disk 100, respectively.

1. An optical disk apparatus, comprises:
a turntable on which either a first optical disk or a second optical disk is placed and held;
an optical pick-up device in which a first objective lens for focusing a light beam on the first optical disk and a second objective lens for focusing a light beam on the second optical disk are installed in the same lens holder; and
controlling means for controlling a position of the lens holder so that a distance between the lens holder and the lens-holder-side surface of the second optical disk when the second optical disk is being reproduced is longer than a distance between the lens holder and the lens-holder-side surface of the first optical disk when the first optical disk is being reproduced.

2. The optical disk apparatus according to claim 1, wherein the first objective lens is installed at a nearer side from the optical disk than the second objective lens is, and wherein
denoting the working distance of the first objective lens as WDₛ, the working distance of the second objective lens as WD₁, and a maximum value of the deviation of recording layer positions of the second optical disk in an optical-axis direction that is generated by rotation of the second optical disk as δD₁,
a difference a between a distance from the lens holder to the lens-holder-side surface of the second optical disk when the light beam passes through the second objective lens and is in focus on the second optical disk and a distance from the lens holder to the lens-holder-side surface of the first optical disk when the light beam passes through the first objective lens and is in focus on the first optical disk satisfies
α>δD₁−WDₛ.

3. The optical disk apparatus according to claim 1, wherein the optical pick-up device has a structure that comprises a magnetic circuit part and a coil assembled in the lens holder and positions the lens holder in an optical-axis direction by interaction between the magnetic circuit part and the coil that is caused by feeding an offset signal to the coil, and
a distance corresponding to a difference between an offset signal when a light beam passes through the first objective lens and is in focus on the first optical disk and an offset signal when the light beam passes through the second objective lens and is in focus on the second optical disk is the above-mentioned α.

4. The optical disk apparatus according to claim 1, wherein the first objective lens and the second objective lens focus a first light beam and a second light beam that have different wavelengths, respectively.

5. An optical pick-up device in which a first objective lens for focusing a light beam on a first optical disk and a second objective lens for focusing a light beam on a second optical disk are installed in the same lens holder,
wherein
denoting the working distance of the first objective lens installed at the near side from the, optical disk as WDₛ and the working distance of the second objective lens installed at the far side from the optical disk as WD₁,
the first objective lens and the second objective lens are installed in the lens holder so that a difference X between a distance from a vertex position of the optical-disk-side lens surface of the first objective lens to the optical disk in an optical-axis direction and a distance from a vertex position of the optical-disk-side lens surface of the second objective lens to the optical disk satisfies
0≦X≦WD₁−WDₛ (where WD₁>WDₛ).

6. The optical pick-up device according to claim 5, wherein denoting a maximum value of the deviation of recording layer positions of the second optical disk in the optical-axis direction that is generated by rotation of the second optical disk as δD₁,
the first objective lens and the second objective lens are installed so that a difference X between a distance from a vertex position of the optical-disk-side lens surface of the first objective lens to the optical disk in the optical-axis direction and a distance from a vertex position of the optical-disk-side lens surface of the second objective lens to the optical disk satisfies
0≦X<WD₁−δD₁ (where δD₁>WDₛ).

7. The optical pick-up device according to claim 6, wherein a maximum value of the deviation of recording layer positions δD₁ is set to a maximum permissible quantity of the deviation described in the Standard Book of the second optical disk.

8. The optical pick-up device according to claim 6, wherein a maximum value of the deviation of recording layer positions δD₁ is set to 0.3 mm.

9. The optical pick-up device according to claim 5, wherein the numerical aperture of the first objective lens is in the range of approximately 0.75 to 0.90, the numerical apertures of the second objective lens are in the range of approximately 0.60 to 0.67 and also in the range of approximately 0.43 to 0.55, respectively.

10. The optical pick-up device according to claim 2, wherein the first objective lens and the second objective lens are compatible with light beams of different wavelengths, namely a light beam of a first wavelength and a light beam of a second wavelength, respectively.

11. The optical pick-up device according to claim 10, wherein the second objective lens has a function of focusing a light beam of a third wavelength on a third optical disk.

12. An optical pick-up device according to claim 11 on which the first objective lens and the second objective lens are mounted,
wherein the first wavelength is in a rage of approximately 390 to 410 nm, the second wavelength is in the range of approximately 630 to 670 nm, and the third wavelength is in the range of approximately 770 to 810 nm.

13. An optical disk apparatus comprising:
an optical pick-up device in which a first objective lens for focusing a light beam on a first optical disk and a second objective lens for focusing a light beam on a second optical disk are installed in the same lens holder;
a turntable on which either the first optical disk or the second optical disk is placed and held; and
a control circuit for switching the objective lens according to the kind of the optical disk that is placed and held on the turntable,
wherein
denoting the working distance of the first objective lens installed at the near side from an optical disk placed and held on the turntable as WDₛ and the working distance of the second objective lens installed at the far side from the optical disk placed and held on the turntable as WD₁,
the first objective lens and the second objective lens are installed in the lens holder so that a difference X between a distance from a vertex position of the optical-disk-side lens surface of the first objective lens to the optical disk in an optical-axis direction and a distance from a vertex position of the optical-disk-side lens surface of the second objective lens X to the optical disk satisfies
0≦X<WD₁−WDₛ (where WD₁>WDₛ).

14. The optical disk apparatus according to claim 13, wherein the optical disk pick-up device is such that denoting a maximum value of the deviation of recording layer positions of the second optical disk in the optical-axis direction that is generated by rotation of the second optical disk as δD₁,
the first objective lens and the second objective lens are installed so that a difference X between a distance from a vertex position of the optical-disk-side lens surface of the first objective lens to the optical disk in the optical-axis direction and a distance from a vertex position of the optical-disk-side lens surface of the second objective lens to the optical disk satisfies
0≦X<WD₁−δD₁ (where δD₁>WDₛ).

15. The optical disk apparatus according to claim 14, wherein the optical pick-up device is such that a maximum value of the deviation of recording layer positions δD₁ is set to a maximum permissible quantity that is described in the Standard Book of the second optical disk.

16. The optical disk apparatus according to claim 14, wherein a maximum value of the deviation of recording layer positions δD₁ is set to 0.3 mm.

17. The optical disk apparatus according to claim 13, wherein the optical pick-up device is such that the numerical aperture of the first objective lens is in the range of approximately 0.75 to 0.90 and the numerical apertures of the second objective lens are in the range of approximately 0.60 to 0.67 and also in the range of approximately 0.43 to 0.55, respectively.

18. The optical disk apparatus according to claim 13, wherein the optical pick-up device is such that the first objective lens and the second objective lens are compatible with light beams of different wavelengths, namely a light beam of a first wavelength and a light beam of a second wavelength, respectively.

19. The optical disk apparatus according to claim 18, wherein the optical pick-up device is such that the second objective lens has a function of focusing a light beam of a third wavelength on a third optical disk.

20. The optical disk apparatus according to claim 18, wherein the optical pick-up device is one on which the first objective lens and the second objective lens are mounted and such that the first wavelength is in the range of approximately 390 to 410 nm, the second wavelength is in the range of approximately 630 to 670 nm, and the third wavelength is in the range of approximately 770 to 8410 nm.

21. A method of reproducing an optical disk equipped with a lens holder on which a first objective lens compatible with a first optical disk and a second objective lens compatible with a second optical disk are mounted,
wherein a distance between the lens holder and the lens-holder-side surface of the second optical disk when a light beam passes through the second objective lens to reproduce the second optical disk is set longer than a distance between the lens holder and the lens-holder-side surface of the first optical disk when a light beam passes through the first objective lens to reproduce the first optical disk.
